(19) United States
(12) Patent Application Publication
(10) Pub. No.: US 2023/0232918 A1
(43) Pub. Date: Jul. 27, 2023

(54) ADHESIVE FACIAL MASK

(71) Applicant: Mark HUESGES, Muenchen (DE)

(72) Inventor: Mark HUESGES, Muenchen (DE)

(21) Appl. No.: 18/001,731

(22) PCT Filed: Jun. 14, 2021
(86) PCT No.: PCT/EP2021/065999

§ 371 Date: Dec. 14, 2022

(30) Foreign Application Priority Data
Jun. 16, 2020 (EP) 20180255.0

(51) Int. Cl. A41D 13/11; A62B 18/02

(52) U.S. Cl. CPC A41D 13/1176; A62B 18/02

(57) ABSTRACT

A facial mask for covering at least a part of a face of a user having at least one filter layer configured to filter air passing through the facial mask and having an outer surface being directed towards a skin of the user and an inner surface arranged opposite to the outer surface of the at least one filter layer. The mask further comprises an at least partly elastic carrier layer with an inner surface, which is directed towards the inner surface of the at least one filter layer, and an outer surface arranged opposite to the inner surface of the carrier layer. A size of the carrier layer is larger than a size of the at least one filter layer, such that a fixing portion of the carrier layer surrounds the at least one filter layer along at least a part of a perimeter of the at least one filter layer.

### TECHNICAL FIELD

The present invention relates to the field of facial masks for covering at least a part of a face, such as at least a part of a mouth and a nose, of user or wearer. In particular, the present invention relates to an at least partly adhesive and/or self-adhesive facial mask, to a use of a facial mask and to a method of fabricating a facial mask.

### TECHNICAL BACKGROUND

Facial masks are widely used for various purposes. For instance, medical doctors or clinical staff usually wear facial masks while being present in an operating room or theatre to prevent spread of germs during surgery. However, facial masks are increasingly used in other fields, including offices, universities and schools, as well as in the public domain, such as by civilians in public transportation, shopping malls, at events, or the like.

Typically, facial masks comprise an air-permeable filter covering the mouth and nose of the user and one or more straps to fix the mask or filter to the user's head. For instance, the one or more straps can be tied around the user's neck, head and/or ears.

These conventional facial masks can have certain drawbacks that can limit their applicability or usability for certain users and use cases or applications. For instance, the above-mentioned fixation of the filter using one or more straps can be uncomfortable for the user and may not sufficiently fix the filter to the user's face, for example in case the user's head is subject to quick movements or the like, such as during physical activities or sports. Further, conventional facial masks usually cover a large area of the user's face, which may adversely affect the user's comfort and aggravate visibility of facial expressions.

### SUMMARY

For the reasons set out hereinabove, it may be desirable to provide for an improved facial mask for covering at least a part of a face of a user that at least mitigates or even overcomes some of or all of the drawbacks of conventional facial masks. This may in turn increase usability of the facial mask in many different fields both in the professional as well as in the public domain.

The invention is defined in the independent claims, wherein further embodiments are incorporated in the dependent claims and the following description.

An aspect of the present invention relates to a facial mask for covering at least a part of a face of a user, such as e.g. at least a part of a nose and a mouth of the user. The mask comprises at least one filter layer configured to filter air passing through the facial mask, wherein the filter layer comprises an outer surface configured for being directed towards a skin of the user and an inner surface arranged opposite to and/or opposing the outer surface of the at least one filter layer. The facial mask further comprises a carrier layer with an inner surface, which is directed towards the inner surface of the at least one filter layer, and an outer surface arranged opposite to and/or opposing the inner surface of the carrier layer. Therein, at least a part and/or portion the carrier layer is elastically stretchable, stretchable, elastically deformable and/or deformable in at least one spatial direction. Further, a size and/or area of the carrier layer is larger than a size and/or area of the at least one filter layer, for instance in a non-deformed state of the carrier layer and the filter layer, such that a fixing portion of the carrier layer surrounds the at least one filter layer along at least a part of a perimeter of the at least one filter layer. The size of the filter layer and/or the carrier layer may be given by a length and width of the respective layer. Moreover, the carrier layer comprises an adhesive material arranged at at least a part of the inner surface of the carrier layer, such that the inner surface of the at least one filter layer is fixedly attached to the inner surface of the carrier layer and/or such that the at least one filter layer is fixedly attached to the carrier layer, and such that the fixing portion of the carrier layer is attachable and/or can be attached to the skin of the user by the adhesive material.

Accordingly, the adhesive material of the carrier layer can be configured for fixing the filter layer to the carrier layer and for fixing the carrier layer and/or the facial mask to the user's skin. This can render further fixation means, such as straps as used for conventional masks, unnecessary, while ensuring that the facial mask can be robustly and reliably affixed to the user's face. Moreover, it can be ensured that no mouth or nose contact is possible while wearing the facial mask, because displacements of the facial mask can be reliably prevented. In turn, droplet infection or airborne infection can be reliably prevented.

In addition, due to the elastically deformable and/or stretchable properties of the carrier layer, and optionally of the filter layer, in combination with the fixability of the mask via the fixing portion of the carrier layer, a comfort for the user may be significantly increased when compared to conventional masks. This relates to both the comfort in wearing, e.g. because the mask can elastically adapt to movements of the user's facial skin, as well as the climate comfort, e.g. because insulating air layers or enclosures between the mask and the skin can be reduced.

Moreover, due to the design of the facial mask with the fixing portion that is attachable to the user's skin, an area of the user's face that is covered by the mask during wearing can be minimized, which can allow for a better identity recognition, and visibility of facial expressions. Hence, interactive communication can be improved.

For at least these reasons, the facial mask according to the present disclosure can be used to advantage in basically any field of application, including sports activities, physical activities, events, concerts, meetings, learning activities, schools, universities, offices, public transportation systems, medical applications, surgical applications, and others.

Also, a cost-efficient production of facial masks for any field of application or for any application can be provided, e.g. requiring only minimum or even no modification of the facial mask for different applications. Further, facial masks can be provided in different sizes for users of nearly any age in a cost-efficient manner, while maintaining the advantageous characteristics and properties of the facial mask.

In the context of the present disclosure, the at least one filter layer may refer to an air-permeable filter comprising one or more layers of filter material. The at least one filter layer and/or the outer surface thereof may be in direct or indirect contact with the user's skin, when the mask is worn by the user. The at least one filter layer may be replaceable or may be fixedly attached to the carrier layer.

Accordingly, the filter layer may be in direct contact with the skin or one or more further layers may be comprised or disposed between the skin and the at least one filter layer. Such one or more further layers may be attached to the at least one filter layer and/or to the carrier layer, e.g. via the adhesive material arranged at the carrier layer and/or via another fixation. For instance, a pocket or compartment may be formed by one or more further layers, e.g. comprising multiple layers and/or a 3 ply material, in which the at least one filter layer may be at least partly arranged. Therein, the one or more further layers forming the pocket or compartment can be attached to the carrier layer via the adhesive material and/or another fixation arranged thereon, and the at least one filter layer may be held by the one or more further layers and/or may be attached to the carrier layer via the one or more further layers. Hence, the at least one filter layer can be directly attached to the carrier layer via the adhesive material or can be indirectly attached to the carrier layer, e.g. via one or more further layers. Generally, the one or more further layers may comprise the same or different material than the at least one filter layer. The one or more furthers layer may for example be configured for absorbing moisture or sweat, and/or for skin protection.

In the context of the present disclosure, the elastic stretchability and/or deformability of the carrier layer (and/or any other layer) in at least one spatial direction may mean that upon exerting a force along the at least one spatial direction, a length of the carrier layer can be increased, wherein the carrier layer contracts itself to its original length when the force is reduced again. Generally, elastically deformable may mean that the length of the carrier layer and/or any other layer referred to in the present disclosure can be elastically increased by at least 10%, for example at least 15%, at least 20%, at least 25%, at least 30%, at least 40%, at least 50%, or even more, relative to a length of the carrier layer and/or the respective layer measured along the at least one spatial direction when no force is exerted.

It should be noted that the at least one filter layer may be inelastic and/or not elastically deformable, at least when compared to the carrier layer. Accordingly, the at least one filter layer may be less elastically deformable than the carrier layer or the filter layer may have elastic properties similar (or identical) to those of the carrier layer.

When the at least one filter layer is less elastic than the carrier layer, the elastic deformability and/or stretchability of the carrier layer may be reduced in a region or portion of the carrier layer that is attached and/or coupled to the at least one filter layer, such as e.g. a middle portion of the carrier layer. Further, the fixing portion of the carrier layer may be more elastic, more elastically deformable and/or more stretchable than the middle region of the carrier layer. This may allow for a reliable and comfortable fixation of the mask on the user's face via the fixing portion. Optionally, a size or area of the fixing portion may be increased, e.g. if the at least one filter layer is less stretchable than the carrier layer and/or if the middle region of the carrier layer is less stretchable than the fixing portion of carrier layer.

Further, the fixing portion may refer to a part or portion of the carrier layer that at least partly surrounds the at least one filter layer along a perimeter and/or circumference thereof. For instance, the fixing portion may extend radially outward from at least a part of a boundary of the at least one filter layer. At at least a part or portion of the fixing portion the adhesive material may be arranged. For instance, the fixing portion may entirely surround the at least one filter layer and adhesive material may be arranged at the entire fixing portion, such that a closed compartment can be formed by the user's skin and the fixing portion. Alternatively, at at least a part or portion of the perimeter of the at least one filter layer no fixing portion may be formed and/or at at least a part of the fixing portion no adhesive material may be arranged.

For instance, a portion of the carrier layer and/or of the fixing portion for covering the user's chin may be adhesive-free and configured for not being attached to the user's skin. Such portion may be designed or formed as a flap extending downwards, when the mask is worn by a user. This may, for example, allow to take a drink, insert or remove a gumshield during sports, disgorge, or the like.

Generally, the adhesive material may in the context of the present disclosure refer to any adhesive material allowing to attach the fixing portion to the user's skin. As noted above, the adhesive material may be configured to attach the fixing portion to the skin and to attach or fix the inner surface of the at least one filter layer to the inner surface of carrier layer, either directly or via one or more further layers that are attached to the carrier layer. The adhesive material may be arranged or disposed at the inner surface of the carrier layer in the form of an adhesive layer. Alternatively or additionally, at least a part of the carrier layer may be impregnated, coated and/or saturated with the adhesive material.

Optionally, the adhesive material may be covered with a protection layer that may be pulled off in order to use the mask. Alternative or additionally, an adhesive effect or force of the adhesive material may be triggered or activated, for instance by application of pressure or thermal energy, when attaching the mask to the user's skin. Optionally, instructions for use, such as instructions for applying the mask on the face, may be printed and/or illustrated on the protection cover.

Further, the adhesive material may be elastically deformable along at least one spatial direction, particularly without losing its adhesive effect or force. Therein, the adhesive material may have similar, like, identical or different elastic properties than the carrier layer. Similarly, the at least one filter layer and/or any other layer comprised in the mask may have similar, like, identical or different elastic properties than the carrier layer

According to an embodiment, the adhesive material is arranged substantially across the entire inner surface of the carrier layer, e.g. including the fixing portion. Accordingly, the adhesive material may cover substantially the entire inner surface of the carrier layer. Therein, substantially may mean at least 90%-95% of the inner surface of the carrier layer.

Generally, this may allow to reliably fix the at least one filter layer, directly or indirectly, to the carrier layer, while ensuring that the adhesive material is disposed at a sufficient portion or area of the fixing portion allowing to reliably attach the mask to the user's skin. Further, such design may allow for a cost-efficient production of the facial mask.

According to an embodiment, the at least one filter layer is attached, bonded and/or coupled to the carrier layer by a coupling means or a plurality of (same or different) coupling means. The coupling means may generally refer to or relate to an additional bonding, i.e. a bonding or coupling of the at least one filter layer and the carrier layer in addition to the coupling or bonding provided by the adhesive material. For example, the coupling means can comprise one or more of a welding connection, a welding coupling, a rolled coupling, a rolled connection, a glue connection, s stitching, and the like. The coupling means may be arranged at at least a part or portion of the filter. For example, the coupling means can be arranged at a perimeter of the at least one filter layer. Optionally, the coupling means can surround the at least one filter layer at at least a part of a perimeter or the entire perimeter of the filter layer. However, the coupling means can be provided at multiple sections of the filter layer, for example at at least two opposing sides thereof. It is emphasized, though, that the coupling means may alternatively or additionally be arranged at at least a part of a center portion of the at least one filter layer and/or multiple (same or different) coupling means can be provided at different parts or portions of the filter layer. The coupling means may advantageously secure the filter layer to the carrier layer to ensure that the filter layer is arranged at the correct position of the carrier layer.

According to an embodiment, the at least part and/or portion of the carrier layer is elastically deformable and/or stretchable in at least two spatial directions, such as at least two transverse and/or perpendicular spatial directions. Accordingly, by exerting two forces to the carrier layer along the at least two spatial directions, an area of the carrier layer may be elastically increased along said at least two spatial directions. Generally, the area of the carrier layer (and/or any other layer referred to in the present disclosure) can be elastically increased by at least 10%, for example at least 15%, at least 20%, at least 25%, at least 30%, at least 40%, at least 50%, or even more, relative to an area of the carrier layer (and/or the respective layer) when no force is exerted.

According to an embodiment, the at least one filter layer is elastically deformable and/or stretchable in one or more spatial directions. Therein, the at least one filter layer may have similar, like, identical or different elastic properties than the carrier layer. For instance, the at least one filter layer may be less elastic than the carrier layer.

According to an embodiment, the at least one filter layer is at least partly foldable. When using the mask, the at least one filter layer may be unfolded or may stay in the folded state. For instance, depending on the size of the user's face and/or depending on the extent the carrier layer is stretched when the mask is worn, more or less layers (or sub-layers) of the filter layer may be unfolded to fit to the user's face. Also, a number of filter layers (or sub-layers) arranged between the user's face and the carrier layer may be varied by folding or unfolding the at least one filter layer.

According to an embodiment, the mask is a self-adhesive facial mask and/or the adhesive material of the carrier layer is a self-adhesive material. This may mean that no additional fixation means, such as one or more straps, may be required to fix the mask to the user's face.

According to an embodiment, the adhesive material of the carrier layer comprises an acrylate adhesive, a silicone gel, or a combination thereof. Such adhesive materials may provide a sufficient adhesive force for reliably attaching the mask to the face, while also being skin-friendly and non-allergic as well as elastic and/or stretchable. Also, such adhesive materials may allow to re-use the facial mask several times, while substantially maintaining the adhesive properties. It should be noted, however, that any other suitable adhesive material may be used.

For instance, different types of adhesive material may be combined. The adhesive material may for example be pressure-sensitive and/or heat-sensitive, such that an adhesive effect is triggered by applying pressure and/or heat.

According to an embodiment, the carrier layer comprises a fabric and/or a yarn, which is at least partly coated by the adhesive material.

According to an embodiment, the carrier layer comprises a weft-knitted fabric, a knitted, and/or a woven material. Such materials may be advantageous in terms of climate comfort, thermal exchange, skin breathability, and moisture transport. Also, a breathing resistance may be reduced for the user. It should be noted, however, that the carrier layer can comprise other material, such as e.g. a warp-knitted fabric.

According to an embodiment, the carrier layer comprises an elastically deformable and/or stretchable fabric formed by a monofilament yarn, a multifilament yarn, cotton, lycra, spandex or a combination thereof. For example, the fabric of the carrier layer and/or the carrier layer may comprise about 95% (weight %) cotton and about 5% spandex (weight %). However, other combinations or compositions are conceivable.

According to an embodiment, the carrier layer comprises an elastically deformable and/or stretchable fabric, which is at least partly formed by an elastically deformable and/or stretchable yarn. Alternatively or additionally, the carrier layer can comprise a fabric, which is elastically deformable and/or stretchable in at least two transverse spatial directions.

Accordingly, the carrier layer may be elastically deformable and/or stretchable due to the elastic yarn and/or due to the stretchable fabric. Using an elastic yarn and/or stretchable fabric for the carrier layer may allow to further increase elasticity and/or stretchability of the carrier layer. In turn, comfort in wearing can be increased and an adaption of the size and geometry of the mask to faces of different sizes and geometries can be provided.

According to an embodiment, the at least one filter layer comprises at least one of a melt-blown filter and a carbon filter. However, the invention is not limited to such filters. Rather, any other suitable type of filter material can be used.

According to an embodiment, a material of the at least one filter layer, a material of the carrier layer and/or the adhesive material of the carrier layer is non-allergic and/or skin-friendly. Hence, skin irritations and/or allergic reactions can be avoided and user comfort can be further increased.

According to an embodiment, the carrier layer comprises at least one vent opening and/or at least one ventilation slot configured to let air pass therethrough. By the at least one vent opening and/or ventilation slot, a breathing resistance may be reduced for the user, which may make the mask particularly suitable for being used during physical activity, such as sports. Generally, the at least one vent opening may have a cross-sectional size or area that is significantly larger than a mesh size of meshes of the carrier layer. The at least one vent opening and/or ventilation slot may be arranged at a middle portion of the carrier layer and/or may be configured for being arranged adjacent the user's nose and/or mouth, such that the user's breathing activity is not or at least not significantly affected by the mask.

According to an embodiment, at least a portion of the carrier layer is perforated and/or comprises one or more cut-outs. For instance, one or more perforation openings and/or cut-outs may be introduced into the carrier layer by laser-cutting, cutting, die cutting, and/or any other mechanical or thermal cutting processes. Generally, a size, cross-sectional size, cross-sectional area, length, geometry and/or shape of the one or more perforation openings and/or cut-outs can be arbitrarily chosen, for instance depending on the application of the mask.

In an example, a size, dimension, cross-sectional size, length and/or width of the at least one vent opening, the perforation openings and/or the cut-out can range from about 1 mm to about 5 cm or even more. In particular, a size, dimension, cross-sectional size, length and/or width of the at least one vent opening, the perforation openings and/or the cut-out can range from about 1 cm to about 3 cm. Therein, the size, length, width, dimension, and/or cross-sectional size of the at least one vent opening, the perforation openings and/or the cut-out can be measured in a cross-sectional plane through the respective at least one vent opening, the perforation openings and/or the cut-out. Such dimensions or sizes of the at least one vent opening, the perforation openings and/or the cut-out have been found by the inventor to provide a minimum breathing resistance to the user, in particular without adversely affecting or reducing a filter effect provided by the mask.

Exemplary perforation openings may be oval or elliptic with a longitudinal axis of the openings being substantially directed from a chin portion of the mask towards a nose portion thereof. Alternatively or additionally, perforation openings arranged at a middle portion or center of the mask can be larger in size than perforation openings arranged near, close to or adjacent to the fixing portion.

In yet a further example, the fixing portion may have a width, measured radially outward from an edge of the at least one filter layer, of at least 0.3 cm, for example at least 0.5 cm, preferably at least about 1 cm to about 5 cm, more preferably at least about 1 cm to about 3.5 cm This may allow to securely attach the mask to the user's face.

Alternatively or additionally, a width of the fixing portion near a nose and/or chin portion of the mask (i.e. a portion of the mask that can be attached to or cover at least a part of the user's nose or chin) may be smaller than a width of the fixing portion at the cheek portions of the mask (i.e. the portions of the mask that can be attached to or cover at least a part of the user's cheeks). Such design may allow to securely attach the mask to the user face by means of the fixing portion at maximum comfort for the user.

According to an embodiment, the carrier layer comprises a middle portion, which is at least partly surround by the fixing portion of the carrier layer along a perimeter and/or circumference of the middle portion, wherein substantially the entire middle portion of the carrier layer is perforated with a plurality of perforation openings. By the perforation openings, a breathing resistance may be reduced for the user, which may make the mask particularly suitable for being used during physical activity, such as sports. Generally, the perforation openings may have a cross-sectional size or area that is significantly larger than a mesh size of meshes of the carrier layer. The middle portion of the carrier layer may be configured for being arranged adjacent the user's nose and/or mouth.

According to an embodiment, a cross-sectional area, size and/or number of the perforation openings per unit area of the carrier layer decreases from a center of the middle portion (or from the middle portion) towards the fixing portion, e.g. in radial direction. Accordingly, a breathing resistance may be efficiently reduced for the user.

According to an embodiment, a cross-section, geometry, and/or shape of the perforation openings is round, rounded, elliptic, oval, slot-like formed, triangular shaped, polygonal shaped, Mercedes star like formed, star-like shaped and/or trapezoidal shaped. It should be noted that the cross-section, geometry, and/or shape of all perforation openings may be identical or perforation openings of different cross-sections, geometries, and/or shapes may be arranged in the carrier layer.

According to an embodiment, the carrier layer comprises at least one cut-out and/or slot arranged laterally at the carrier layer and extending, e.g. radially, through at least a part of the fixing portion of the carrier layer. The cut-out and/or slot may be arranged near one or both cheeks of the user, e.g. improving comfort and wearability for the user.

According to an embodiment, an outer contour of the carrier layer is substantially triangular or trapezoidal. This may allow to cover substantially the entire mouth and nose of the user, while minimizing the coverage of further skin areas by the mask. Hence, person recognition and visibility of facial expressions can be improved.

According to an embodiment, the mask further comprises a nostril improvement. Configured for spreading alar wings of the nose. The nostril improvement may be arranged at an upper part or portion of the mask configured for being arranged opposite and/or adjacent to the nose of the user. The nostril improvement may comprise one or more strips or elongated elements configured for encompassing at least a part of the user's nose. For instance, the one or more strips may be biased and/or pre-stressed, e.g. such that alar wings of the nose can be spread and/or spaced apart from each other by the nostril improvement. Therein, the nostril improvement or at least a part thereof may be in direct contact with at least a part of the user's nose, e.g. the alar wings of the nose. By means of the nostril improvement, it may be ensured that the user can breathe more freely through its nose, making the mask particularly suitable for sports activities.

Optionally, at least a part of the mask may be soaked with a scent, flavor, ethereal oil, an essence, or the like, for instance, in order to open respiratory ducts or pathways of the user. For instance, one or more of such substances can be included in a part or portion of one or more of the carrier layer, the at least one filter layer and one or more further layers. Alternatively or additionally, a pad at least partly soaked with one or more of such substances can be attached to the mask, e.g. inserted into a pocket, a slot, and/or a compartment.

A further aspect of the present disclosure relates to the use of a facial mask, as described hereinabove and hereinbelow, during and/or for a sports activity of the user for reducing a risk of infection of the user and/or of at least one further user.

A further aspect of the present disclosure relates to the use of a facial mask, as described hereinabove and hereinbelow, during and/or for a learning activity, training, education, physical education, an educational session, university, work, and/or school of the user for reducing a risk of infection of the user and/or of at least one further user. It should be noted that the mask according to the present disclosure may also be used for any other application or use, such as medical applications, surgical applications, events, concerts, meetings, shopping malls, retail environments, public transportation, travelling, and/or any area or environment where social distancing may hardly be guaranteed all the time.

According to a further aspect of the present disclosure, there is provided a method of fabricating a facial mask, e.g. a mask as described hereinabove and hereinbelow. The method comprises the steps of:

providing a carrier layer having an inner surface and an outer surface, wherein the carrier layer is at least partly elastically deformable and/or stretchable in at least one spatial direction and comprises an adhesive material arranged at at least a part of the inner surface;

providing at least one filter layer configured to filter air passing through the facial mask, wherein the at least one filter layer comprises an outer surface configured for being directed towards a skin of the user and an inner surface arranged opposite to the outer surface;

arranging the at least one filter layer on and/or relative to the carrier layer, such that the inner surface of the at least one filter layer is directed towards the inner surface of the carrier layer; and

fixedly attaching and/or fixing, by means of the adhesive material arranged at the carrier layer, the inner surface of the at least one filter layer to the inner surface of the carrier layer, such that a fixing portion of the carrier layer surrounds the at least filter layer along at least a part of a perimeter and/or circumference of the at least one filter layer, wherein the fixing portion of the carrier layer is attachable to the skin of the user by means of the adhesive material arranged at the carrier layer.

It should be noted that any feature, function and/or element of the facial mask, as described hereinabove and hereinbelow, can be a feature, step, and/or element of the method, as described hereinabove and hereinbelow, and vice versa. Accordingly, any feature, function, step, and/or element, as described hereinabove and hereinbelow with reference to one aspect of the present disclosure, equally applies to any other aspect of the present disclosure.

The subject matter of the disclosure will be explained in more detail in the following text with reference to exemplary embodiments and examples which are illustrated in the attached drawings.

### BRIEF DESCRIPTION OF THE DRAWINGS

FIG. 1A shows a top view of a facial mask according to an exemplary embodiment.

FIG. 1B shows a cross-sectional view of the facial mask of FIG. 1A.

FIG. 2 shows a facial mask according to an exemplary embodiment worn by a user.

FIG. 3 shows a backside view of a facial mask according to an exemplary embodiment.

FIGS. 4 to 11 each show a facial mask according to an exemplary embodiment.

FIG. 12 shows a flow chart illustrating a method of fabricating a facial mask according to an exemplary embodiment.

The figures are schematic only and not true to scale. In principle, identical or like parts are provided with identical or like reference symbols in the figures.

### DETAILED DESCRIPTION OF EXEMPLARY EMBODIMENTS

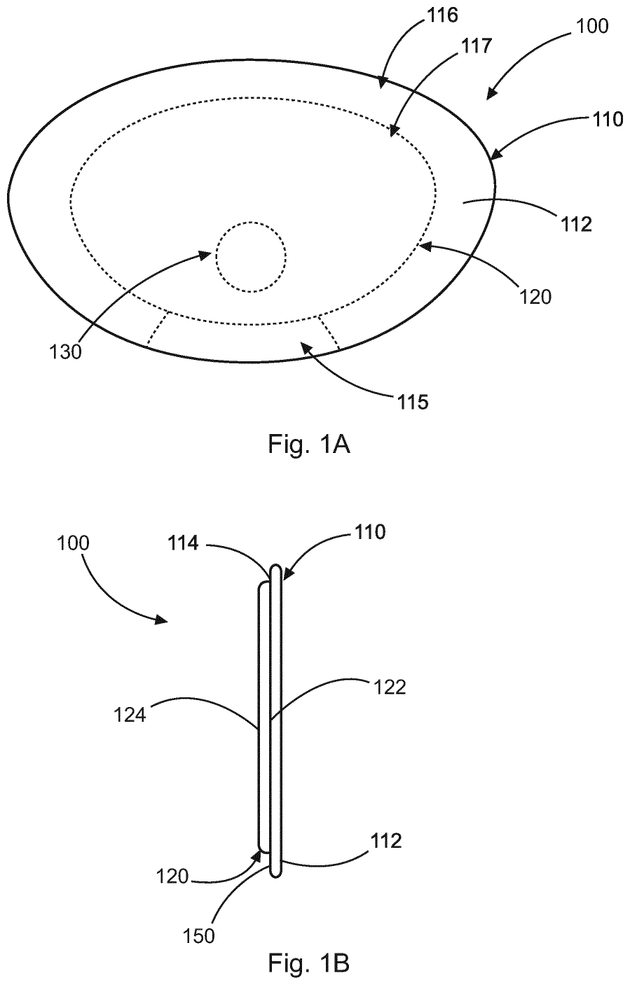

FIG. 1A shows a top view or top-side view of a facial mask 100 according to an exemplary embodiment, and FIG. 1B shows a cross-sectional view of the facial mask 100 of FIG. 1A.

The mask 100 comprises a carrier layer 110 with an outer surface 112 that is directed away from a user's skin (not shown), when the mask 100 is worn, and an inner surface 114 arranged opposite to the outer surface 112.

The mask 100 further comprises at least one air-permeable filter layer 120 with an outer surface 124 configured for being directed towards and/or for being in contact with the user's skin and an inner surface 122 arranged opposite to the outer surface 124 and opposite to the inner surface 114 of the carrier layer 110. Accordingly, the inner surface 122 of the filter layer 120 may be arranged between the outer surface 124 of the filter layer 120 and the inner surface 114 of the carrier layer 110.

In the example shown in FIGS. 1A and 1B, the filter layer 120 adjoins or contacts the carrier layer 110. It should be noted, however, that one or more further layers may be arranged between the filter layer 120 and the carrier layer 110. Alternatively or additionally, one or more further layers may be arranged at the outer surface 124 of the filter layer 120.

In FIG. 1A, a size, extension and/or area of the filter layer 120 is shown by a dashed line. As can be seen in FIG. 1A, a size, extension and/or area of the carrier layer 110 is larger than the size, extension and/or area of the filter layer, such that a fixing portion 116 of the carrier layer 110 radially extends from an edge or border of the filter layer 120.

Moreover, an adhesive material 150 (see FIG. 1B) is arranged at at least a part or portion of the carrier layer 110, including at least a part or portion of the fixing portion 116. By means of the adhesive material 150, the filter layer 120 can be fixedly attached to the carrier layer 120 and the carrier layer 110 and/or the fixing portion can be attached to the user's skin. For instance, the adhesive material 150 may be arranged at substantially the entire outer surface 114 of the carrier layer 110. In particular, the adhesive material 150 may be arranged at at least a part of a middle portion 117 of the carrier layer 110, at which the filter layer 120 is arranged, and at at least a part of the fixing portion 116. Optionally, a part of the fixing portion 116 may not comprise and/or may not be covered or coated with adhesive material 150, such as e.g. a chin part or portion of 115 of the fixing portion 116, which is configured for being arranged opposite to the user's chin.

It should be noted that the filter layer 120 or at least a part thereof may be indirectly attached to the carrier layer 110 via one or more further layers arranged therebetween, which further layers can be attached to the carrier layer 110 by means of the adhesive material 150. The filter layer 120 can be attached to the one or more further layers by a further adhesive material and/or any other connection or coupling. Alternatively or additionally, at least a part of the filter layer 120 can be attached to the carrier layer 110 by a connection or coupling other than the adhesive material 150. E.g. a part of the filter layer 120 can be stitched to the carrier layer 110.

Generally, the adhesive material 150 may comprise acrylate adhesive material, silicone gel, a combination thereof, and/or other adhesive materials or components. The adhesive material 150 may be arranged as a layer 150 on at least a part of the inner surface 14 of the carrier layer 110. Alternatively or additionally, a yarn and/or fabric of the carrier layer 110 may be coated at least partly with the adhesive material 150.

Further, the carrier layer 110 and optionally the filter layer 120 is elastically deformable and/or stretchable in at least one, preferably at least two spatial directions, such that a size and shape of the mask 100 can be adjusted according to the user's demands. Therein, the carrier layer 110 may be more elastic than the filter layer 120.

Further, the carrier layer 110 may comprise an elastically deformable and/or stretchable yarn. By way of example, the carrier layer 110 may comprise cotton and spandex. Alternatively or additionally, the carrier layer 110 may comprise an elastically deformable and/or stretchable fabric, e.g. a woven fabric and/or a weft-knitted fabric.

The filter layer 120 may, for example, comprise a carbon filter and/or a melt-blown filter. It should be noted that the filter layer 120 can be folded in one or more sub-layers to increase a filter effect or to allow for an adjustment in size of the filter layer depending on user-specific needs or demands, as shown in FIG. 3.

For attaching the mask 100 to the face, the user may simply place the mask 100 onto its nose and mouth and gently press the mask 100 against the skin. Due to the adhesive material 150, the mask 100 can be attached to the skin without requiring any additional fixation means, such as straps or the like. Further, the adhesive material 150 may be pressure-sensitive and/or sensitive to heat, such that the mask 100 can be fixed to the face by manually pressing the mask 100 onto the skin.

Optionally, the mask 100 comprises a vent opening 130 and/or a ventilation slot 130 arranged at the middle portion 117 of the carrier layer 110 and configured for letting air pass therethrough.

As can be seen in FIG. 1A, a contour or geometry of the mask 100 is substantially triangular with rounded corners or edges. This may allow for an efficient coverage of the user's mouth and nose, while minimizing coverage of other portions of the user's face. However, other shapes, contours or geometries are conceivable for the mask 100.

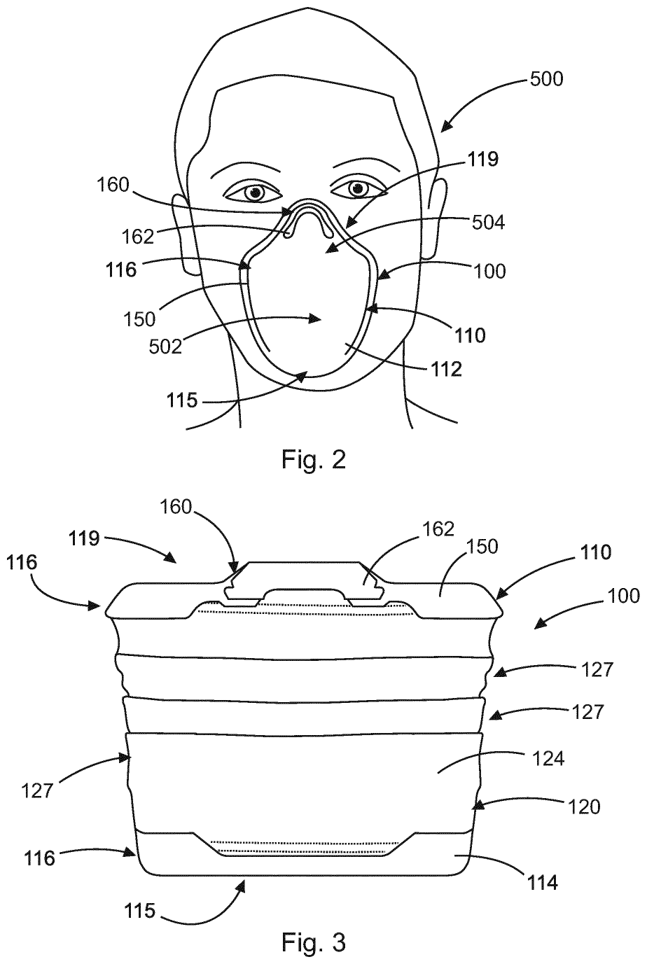

FIG. 2 shows a facial mask 100 according to an exemplary embodiment worn by a user 500. Unless stated otherwise, the mask 100 of FIG. 2 comprises the same features, functions and/or elements as the mask 100 of FIGS. 1A and 1B.

As can be seen, the mask 100 covers at least a part of a face of the user 500. In particular, the mask 100 covers the mouth 502 and the nose 504 of the user 500. Due to the design and configuration of the mask 100 with the adhesive material 150 and the fixing portion 116, a significant part of the user's 500 cheeks may not be covered by the mask 100, which may increase comfort for the user 500 and be of particular advantage when using the mask 100 during sports.

Further, in the embodiment shown in FIG. 2, the fixing portion 116 only partly surrounds and encompasses the filter layer 120, e.g. at an upper portion 119 of the carrier layer 110 arranged adjacent the nose 504 of the user 500. Alternatively or additionally, the adhesive material 150 may only be arranged at a part or portion, e.g. the upper portion 119 of the carrier layer 110. Accordingly, a chin portion 115 of the fixing portion 116 and/or the carrier layer 110 may not comprise adhesive material 150, such that the chin portion 115 of the carrier layer 110 forms a flap and/or serves as a vent opening.

In the embodiment shown in FIG. 2, the mask 100 further comprises a nostril improvement 160 arranged at the upper portion 119 of the mask 100 and configured for being arranged opposite and/or adjacent to the nose 500 of the user 500. The nostril improvement 160 may comprise one or more strips 162 or elongated elements 162 configured for encompassing at least a part of the user's nose 504. For instance, the one or more strips 162 may be biased and/or pre-stressed, e.g. such that alar wings of the nose 504 can be spread and/or spaced apart from each other by the nostril improvement 160. Therein, the nostril improvement 160 or at least a part thereof may be in direct contact with at least a part of the user's nose 504, e.g. the alar wings of the nose. By means of the nostril improvement 160, it may be ensured that the user can breathe more freely through its nose 504, making the mask 100 particularly suitable for sports activities.

FIG. 3 shows a backside view of a facial mask 100 according to an exemplary embodiment. Unless stated otherwise, the mask 100 of FIG. 3 comprises the same features, functions and/or elements as the masks 100 described with reference to the aforegoing figures.

In the example shown in FIG. 3, the filter layer 120 is folded several times to form a plurality of sub-layers 127, as described hereinabove.

Further, also the example of FIG. 3 comprises a nostril improvement 160 as described with reference to FIG. 2.

In the example of FIG. 3, however, the fixing portion 116 comprises an upper portion 119 for being arranged adjacent the nose 504 of the user 500 and a lower portion 115 or chin portion 115 arranged opposite thereto. Further, the upper portion 119, and optionally the lower portion 115 or chin portion 115, may comprise adhesive material 150 for attaching the mask 100 to the user's skin.

On the lateral sides, borders or edges of the carrier layer 110 and/or the mask 100, however, no fixing portion 116 is formed or arranged in the example of FIG. 3. Accordingly, the mask 100 may be attached to the user 500 via the upper portion 119 and optionally via the chin portion 115, whereas the lateral sides, borders or edges may not be fixed to the user's skin. This may allow for an increased air transfer via the lateral sides, borders or edges of the carrier layer 119 and/or of the mask 100.

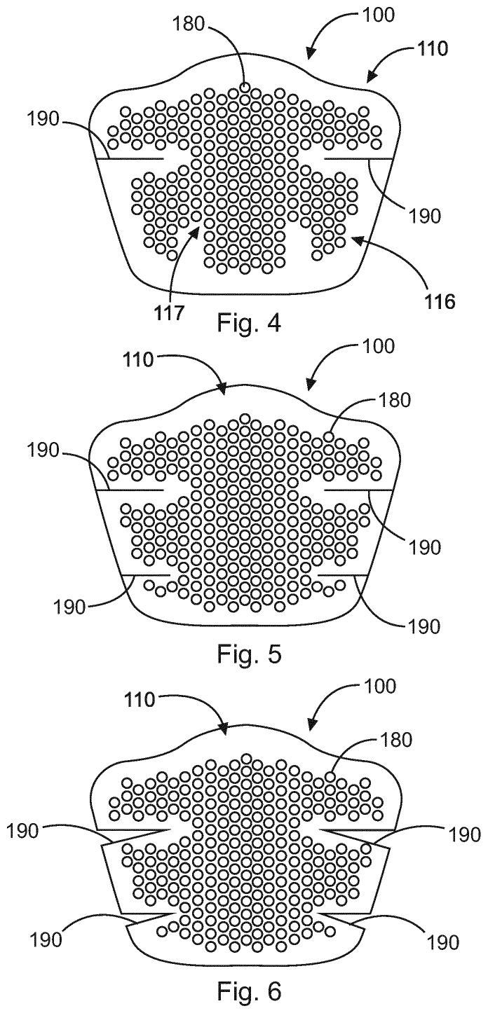

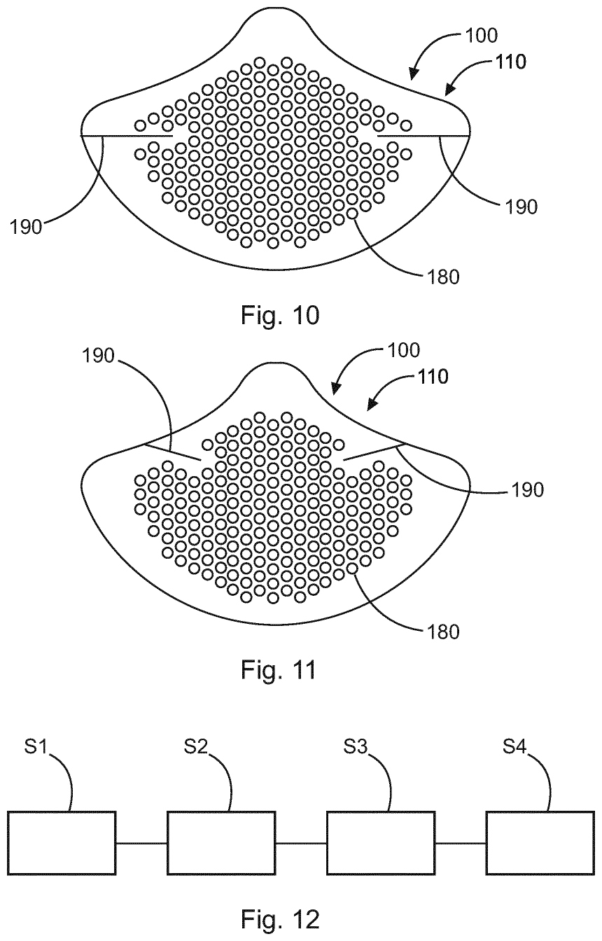

FIGS. 4 to 11 each show a facial mask 100 according to an exemplary embodiment.

Unless stated otherwise, the masks 100 of FIGS. 4 to 11 each comprises the same features, functions and/or elements as the masks 100 described with reference to the aforegoing figures.

In the exemplary embodiments shown in FIGS. 4 to 6 and 8 to 11, the carrier layer 110 and/or the mask 100 comprises a plurality of perforation openings 180 arranged in a pattern on the carrier layer 110, each opening 180 extending through the entire carrier layer 110 parallel to a surface normal vector of the inner surface 114 of the carrier layer 110. Therein, a cross-section of the perforation openings 180 can be round (FIGS. 4 to 6 , 10, 11), rounded (FIGS. 4 to 6 , 10, 11), elliptic (FIG. 9), oval, slot-like formed (FIG. 9), triangular shaped (FIG. 8), polygonal shaped (FIG. 8), Mercedes star like formed (FIG. 8), or trapezoidal shaped. However, any other cross-section and/or geometry of the perforation openings 180 is conceivable.

Also, perforation openings 180 of different geometries, shapes, sizes, and/or cross-sections may be combined. For instance, a cross-sectional area and/or diameter of the perforation openings 180 arranged at a middle portion 117 of the carrier layer 110 may be larger than a cross-sectional area and/or diameter of the perforation openings 180 arranged close to the fixing portion 116. Therein, the cross-sectional area and/or diameter of the perforation openings 180 may step-wise or continuously decrease from the middle portion 117 towards the fixing portion 116 and/or towards the boundaries or edges of the carrier layer 110.

Further, the masks 100 of FIGS. 4 to 11 each comprise at least one cut-out 190 and/or slot 190 arranged laterally at the carrier layer 110 and/or the mask 100 and extending through at least a part of the fixing portion 116 in radial direction. Thereby, deformability of the entire mask 100 can be increased, such that the mask can be adjusted in geometry and shape according to the user's face.

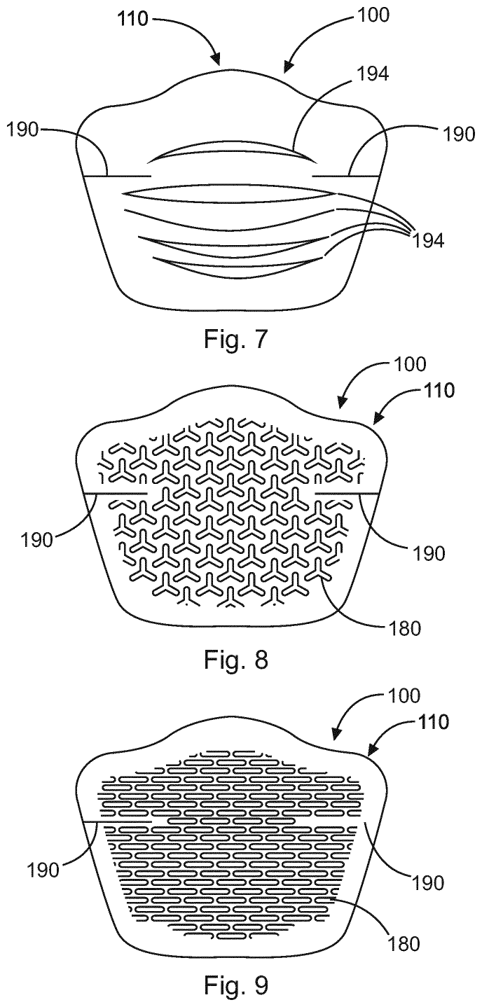

In contrast to the examples of FIGS. 4 to 6, and 8 to 11, the mask 100 of FIG. 7 comprises a plurality of slots 194 and/or ventilation slots 194 arranged in the carrier layer 110 that allow to let pass air therethrough. It should be noted that the ventilation slots 194 can also be combined with one or more perforation openings 180.

The shapes or contours of all masks 100 shown in FIGS. 4 to 11 are substantially triangular. These shapes or contours are illustrative only and many variations are conceivable.

FIG. 12 shows a flow chart illustrating a method of fabricating a facial mask 100 according to an exemplary embodiment. The mask 100 may be one of the masks 100 described hereinabove.

Step S1 comprises providing a carrier layer 110 having an inner surface 114 and an outer surface 112, wherein the carrier layer 110 is elastically deformable and/or stretchable in at least one spatial direction and comprises an adhesive material 150 arranged at at least a part of the inner surface 114.

Step S2 comprises providing at least one filter layer 120 configured to filter air passing through the facial mask 100, wherein the at least one filter layer 120 comprises an outer surface 124 configured for being directed towards a skin of the user and an inner surface 122 arranged opposite to the outer surface 124.

Step S3 comprises arranging the at least one filter layer 120 on the carrier layer 110 and/or relative to the carrier layer 118, such that the inner surface 122 of the at least one filter layer 120 is directed towards and/or opposes the inner surface 114 of the carrier layer 110.

Step S4 comprises fixedly attaching and/or fixing, by means of the adhesive material 150 of the carrier layer 110, the inner surface 122 of the at least one filter layer 120 to the inner surface 114 of the carrier layer 110, such that a fixing portion 116 of the carrier layer 110 surrounds the at least one filter layer 120 along at least a part of a perimeter of the at least one filter layer 120, wherein the fixing portion 116 of the carrier layer 110 is attachable to the skin of the user by means of the adhesive material 150 of the carrier layer 110.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A facial mask for covering at least a part of a face of a user, the mask comprising:
at least one filter layer configured to filter air passing through the facial mask, the filter layer having an outer surface being directed towards a skin of the user and an inner surface arranged opposite to the outer surface of the at least one filter layer; and
a carrier layer with an inner surface, which is directed towards the inner surface of the at least one filter, and an outer surface arranged opposite to the inner surface of the carrier layer;
wherein at least a part of the carrier layer is elastically deformable and/or stretchable in at least one spatial direction,
wherein a size of the carrier layer is larger than a size of the at least one filter layer, such that a fixing portion of the carrier layer surrounds the at least one filter layer along at least a part of a perimeter of the at least one filter layer, and
wherein the carrier layer includes an adhesive material arranged at at least a part of the inner surface of the carrier layer, such that the inner surface of the at least one filter layer is fixedly attached to the inner surface of the carrier layer and such that the fixing portion of the carrier layer is attachable to the skin of the user by the adhesive material.

2. The mask according to claim 1,
wherein the adhesive material is arranged substantially across entire inner surface of the carrier layer.

3. The mask according to claim 1,
wherein the at least a part of the carrier layer is elastically deformable and/or stretchable in at least two spatial directions.

4. The mask according to claim 1,
wherein the at least one filter layer is elastically deformable and/or stretchable in one or more spatial directions.

5. The mask according to claim 1,
wherein the at least one filter layer is at least partly foldable.

6. The mask according to claim 1,
wherein the adhesive material of the carrier layer has an acrylate adhesive, a silicone gel, or a combination thereof.

7. The mask according to claim 1,
wherein the carrier layer has an elastically deformable and/or stretchable fabric formed by a monofilament yarn, a multifilament yarn, cotton, lycra, spandex, or a combination thereof.

8. The mask according to claim 1,
wherein the carrier layer includes an elastically deformable and/or stretchable fabric, which is at least partly formed by an elastically deformable and/or stretchable yarn.

9. The mask according to claim 1,
wherein at least a portion of the carrier layer is perforated.

10. The mask according to claim 1,
wherein the carrier layer includes a middle portion, which is at least partly surrounded by the fixing portion of the carrier layer along a perimeter of the middle portion; and
wherein at least a part of the middle portion of the carrier layer is perforated with a plurality of perforation openings.

11. The mask according to claim 10,
wherein a cross-section of the perforation openings is round, rounded, elliptic, oval, slot-like formed, triangular shaped, polygonal shaped, star-like formed, and/or trapezoidal shaped.

12. The mask according to claim 1,
wherein the carrier layer comprises at least one cut-out arranged laterally at the carrier layer and extending through at least a part of the fixing portion of the carrier layer in a radial direction.

13. The mask according to claim 1, further comprising:
a nostril improvement configured for spreading alar wings of a nose of the user.

14. (canceled)

15. A method of fabricating a facial mask according to claim 1, the method comprising:
obtaining a carrier layer having an inner surface and an outer surface, wherein the carrier layer is at least partly elastically deformable and/or stretchable in at least one spatial direction and includes an adhesive material arranged at at least a part of the inner surface;
obtaining at least one filter layer configured to filter air passing through the facial mask, wherein the at least one filter layer includes an outer surface configured for being directed towards a skin of the user and an inner surface arranged opposite to the outer surface;
arranging the at least one filter layer on the carrier layer and/or relative to the carrier layer, such that the inner surface of the at least one filter layer is directed towards and/or opposes the inner surface of the carrier layer; and
fixedly attaching, by way of the adhesive material of the carrier layer, the inner surface of the at least one filter layer to the inner surface of the carrier layer, such that a fixing portion of the carrier layer surrounds the at least one filter layer along at least a part of a perimeter of the at least one filter layer,
wherein the fixing portion of the carrier layer is attachable to the skin of the user by way of the adhesive material of the carrier layer.
